(19) United States
(12) Patent Application Publication
(10) Pub. No.: US 2003/0070695 A1
(43) Pub. Date: Apr. 17, 2003

(54) N2 splash guard for liquid injection on the rotating substrate

(75) Inventors: Ramin Emami, San Jose, CA (US); Bo Zheng, San Jose, CA (US); Mohsen Salek, Sarajoga, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/981,504

(22) Filed: Oct. 16, 2001

(51) Int. Cl. B08B 5/02

(52) U.S. Cl. 134/33; 134/37; 15/316.1

(57) ABSTRACT

A method and apparatus for removing an edge bead from a substrate. The apparatus includes rotatable substrate support member configured to support a substrate thereon and at least one fluid distribution nozzle positioned to distribute an edge bead removal solution onto the substrate. A conically shaped shield member is positioned above the substrate support member, the shield member having a fluid conduit formed therein and an annular gas distribution nozzle positioned on a lower portion of the shield member, the annular gas nozzle being in fluid communication with the fluid conduit. The method includes rotating a substrate on a substrate support member, dispensing an edge bead removal solution onto an exclusion zone of the substrate with at least one fluid nozzle, and dispensing a gas flow from at least one gas nozzle positioned above the substrate radially inward from the at least one fluid nozzle, the gas flow radiating outward across the exclusion zone.

### BACKGROUND OF THE INVENTION

1. Field of the Invention

The present invention generally relates to edge bead removal systems. More particularly, the present invention relates to a shield used in an edge bead removal process that prevents an edge bead removal solution from splashing onto the production surface of the substrate.

2. Background of the Related Art

In semiconductor device manufacturing, multiple deposition processes, such as chemical vapor deposition (CVD), physical vapor deposition (PVD), electroless plating, electrochemical plating (ECP), and/or other deposition processes, are generally conducted in a process series in order to generate a multilayer pattern of conductive, semiconductive, and/or insulating materials on a substrate. When the series is used to manufacture a multilayer device, a planarization process is generally used planarize or polish the substrate surface between the individual layer deposition steps in order to provide a relatively flat surface for the next deposition step. When an ECP process is used as a deposition step, an edge bead generally forms proximate the perimeter of the substrate, which inhibits effective planarization processes. Therefore, an edge bead removal (EBR) process is generally conducted after an ECP deposition process is complete. The EBR process generally operates to remove unwanted edge beads deposited on the bevel or edge of the substrate during the ECP deposition process, and therefore, allows for effective planarization of the substrate surface.

Metal ECP may be accomplished through a variety of methods using a variety of metals. Copper and copper alloys are generally a choice metal for ECP as a result of copper's high electrical conductivity, high resistance to electromagnetic migration, good thermal conductivity, and it's availability in a relatively pure form. Typically, electrochemically plating copper or other metals and alloys involves initially depositing a thin conductive seed layer over the substrate surface to be plated. The seed layer may be a copper alloy layer having a thickness of about 2000 Å, for example, and may be deposited through PVD or other deposition techniques. The seed layer generally blanket covers the surface of the substrate, as well as any features formed therein. Once the seed layer is formed, a metal layer may be plated onto/over the seed layer through an ECP process. The ECP layer deposition process generally includes application of an electrical bias to the seed layer, while an electrolyte solution is flowed over the surface of the substrate having the seed layer formed thereon. The electrical bias applied to the seed layer is configured to attract metal ions suspended or dissolved in the electrolytic solution to the seed layer. This attraction operates pull the ions out of the electrolyte solution and cause the ions to plate on the seed layer, thus forming a metal layer over the seed layer.

During the ECP process, metal ions contained in the electrolyte solution generally deposit on substrate locations where the solution contacts the seed layer. Although the seed layer is primarily deposited on the front side of the substrate, the seed layer may be over deposited and partially extend onto the edge and backside of the substrate. As such, metal ions from the electrolyte solution may deposit on the edge and backside portions of the substrate during an ECP process if the electrolyte solution contacts these portions of the substrate having the over deposited seed layer formed thereon. For example, FIG. 1A illustrates a cross sectional view of a substrate 22 having a seed layer 32 deposited on the substrate surface 35. Seed layer 32 extends to a radial distance proximate the bevel edge 33 of substrate 22 and may be deposited, for example, with a CVD or a PVD process. A conductive metal layer 38 is deposited on top of seed layer 32, through, for example, an ECP process. As a result of the seed layer 32 terminating proximate bevel 33, an excess metal layer buildup, known as an edge bead 36, generally forms proximate the bevel 33 above the terminating edge of the seed layer 32. Edge bead 36 may result from a locally higher current density at the edge of seed layer 32 and usually forms within 2-5 mm from the edge of the substrate. FIG. 1B illustrates a similar edge bead 36, and includes an illustration of a metal layer 38 extending around the bevel 33 of substrate 22 onto backside 42. This situation occurs when the seed layer 32 extends around bevel 33 onto backside 42 and comes into contact with the electrolyte during ECP process. Edge bead 36 must generally be removed from the substrate surface before further layers may be deposited thereon or before substrate processing is complete, as edge bead 36 creates a deformity in the planarity of the substrate surface that does not facilitate multilayer device formation.

EBR systems operate to remove the over deposited seed and metal layers from the edge and backside portions of the substrate. Generally, there are two primary types of EBR systems, nozzle-type EBR systems and capillary-type EBR systems. Nozzle-type EBR systems generally rotate a substrate below a nozzle that sprays a metal removing solution onto the substrate proximate the exclusion zone, and possibly on the backside of the substrate, in order to remove the edge bead and any over deposited metal layers. However, a disadvantage of nozzle-type EBR systems is that the spray of the metal removing solution onto the substrate surface is prone to splashing, misting, and/or overspray. This is a significant disadvantage, as the metal removing solution is generally a strong etchant, and therefore, when a mist or splash of the solution contacts the production surface of the substrate, pitting occurs, which damages the devices formed on the production surface.

Therefore, there is a need for a nozzle-type EBR system capable of dispensing a metal removing solution onto an exclusion zone without splashing removal solution onto the production surface of the substrate.

### SUMMARY OF THE INVENTION

Embodiments of the invention generally provide an apparatus for removing an edge bead from a substrate. The apparatus includes rotatable substrate support member configured to support a substrate thereon and at least one fluid distribution nozzle positioned to distribute an edge bead removal solution onto the substrate. A conically shaped shield member is positioned above the substrate support member, the shield member having a fluid conduit formed therein and an annular gas distribution nozzle positioned on a lower portion of the shield member, the annular gas nozzle being in fluid communication with the fluid conduit.

Embodiments of the invention further provide a method for removing an edge bead from a substrate. The method includes rotating a substrate on a substrate support member, dispensing an edge bead removal solution onto an exclusion zone of the substrate with at least one fluid nozzle, and dispensing a gas flow from at least one gas nozzle positioned above the substrate radially inward from the at least one fluid nozzle, the gas flow radiating outward across the exclusion zone.

Embodiments of the invention further provide an apparatus for removing an edge bead from a substrate. The apparatus includes a rotatable substrate support member configured to support a substrate in a face up position, at least one fluid distribution nozzle positioned to distribute an edge bead removal solution onto an exclusion zone of the substrate, and at least one shield member positioned proximate each of the at least one fluid distribution nozzles, each of the at least one shield members having a gas distribution nozzle positioned thereon.

Embodiments of the invention further provide an apparatus for removing an edge bead from a substrate. The apparatus includes a rotatable substrate support member configured to receive a substrate thereon in a face up position, at least one fluid distribution nozzle positioned above the substrate support member and being configured to dispense an edge bead removal solution onto an exclusion zone of the substrate, and means for shielding a production surface of the substrate from the edge bead removal solution.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B illustrate exemplary edge beads formed by electrochemical plating processes.

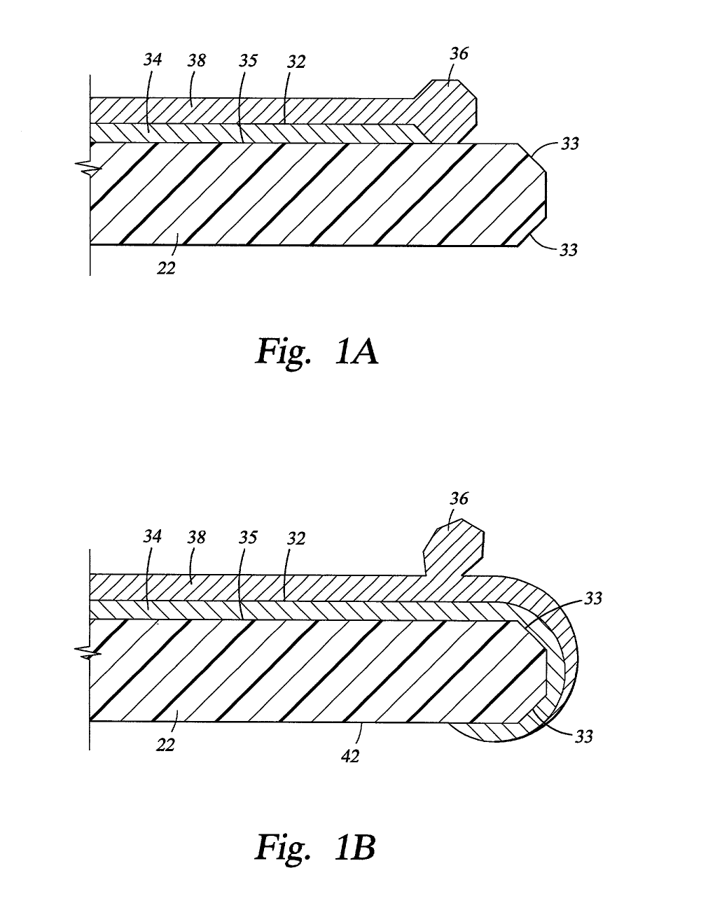

FIG. 2A illustrates a perspective view of an exemplary processing system incorporating an embodiment of the EBR chamber of the invention.

FIG. 2B illustrates a plan view of the exemplary processing system shown in FIG. 2A.

FIG. 3 illustrates a sectional view of an exemplary EBR chamber of the invention.

FIG. 4 illustrates a partial plan view of an exemplary EBR chamber of the invention.

FIG. 5 illustrates a perspective view of the splash guard illustrated in FIGS. 3 and 4.

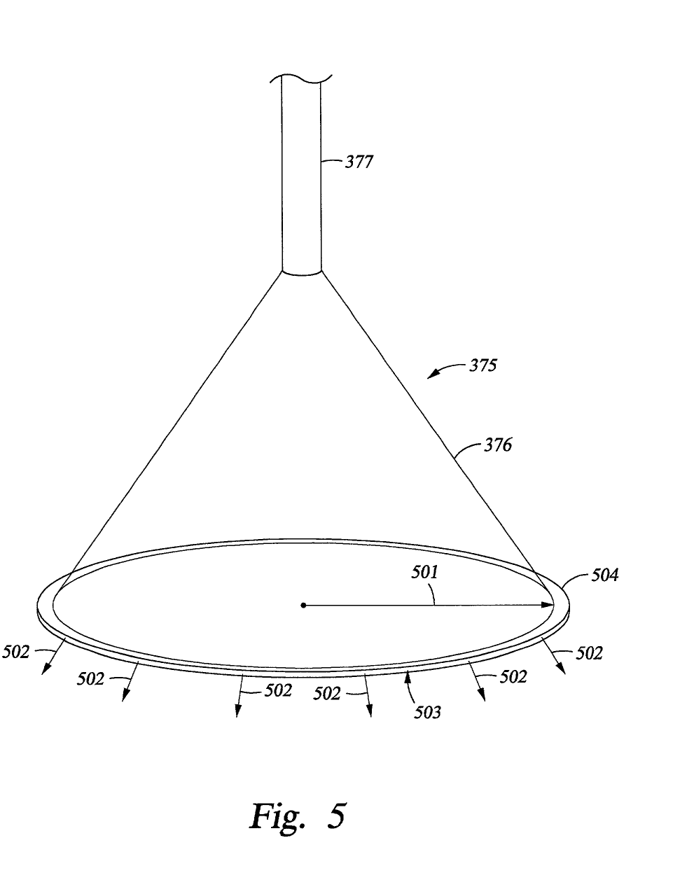

FIG. 6 illustrates a sectional view of an exemplary EBR chamber.

FIG. 7 illustrates a partial plan view of the exemplary EBR chamber shown in FIG. 6.

FIG. 8 illustrates a perspective view of the splash guard illustrated in FIGS. 6 and 7.

### DETAILED DESCRIPTION OF THE PREFERRED EMBODIMENT

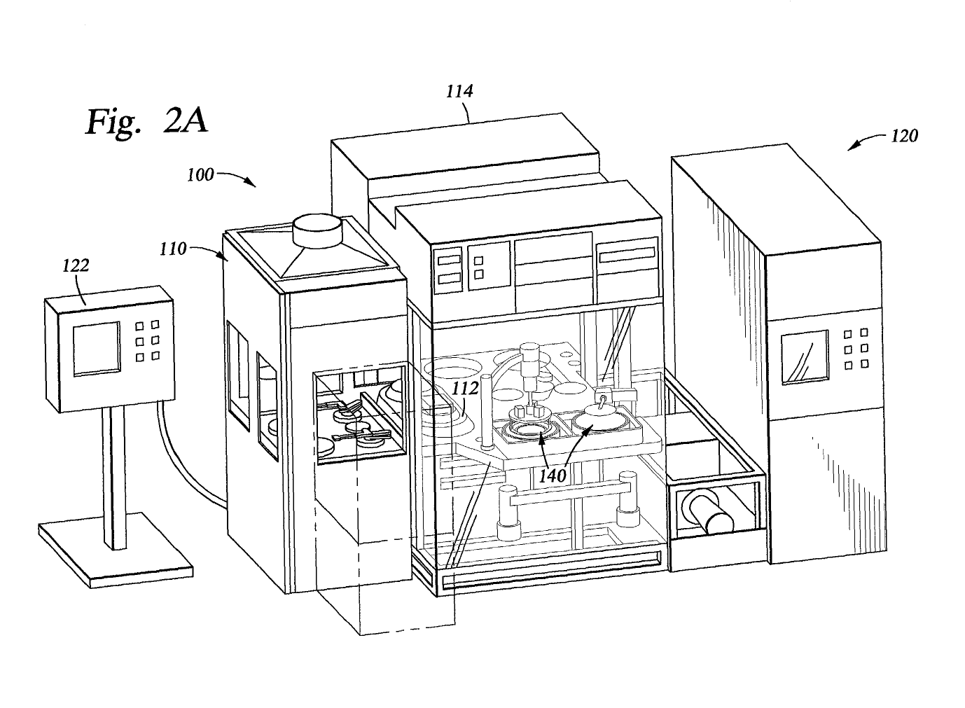

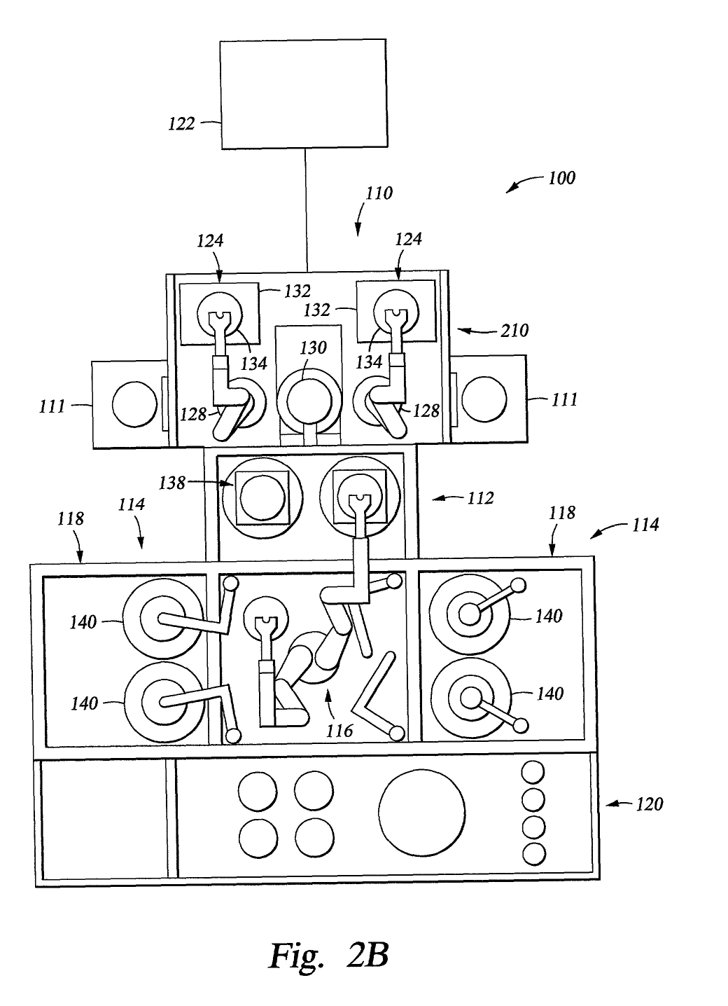

FIG. 2A illustrates a perspective view of a processing system incorporating an EBR chamber of the invention. System platform 100 generally includes a loading station 110, a thermal anneal chamber 111 (shown in FIG. 2B), a spin-rinse-dry (SRD) station 112, a mainframe 114, and a chemical replenishing system 120. Preferably, system platform 100 is enclosed in a clean room-type environment using, for example, plexiglass panels to separate system platform 100 from the unfiltered environment. Mainframe 114 generally includes a mainframe transfer station having at least one transfer robot 116 positioned therein, along with a plurality of processing stations 118 positioned around robot 116. Each processing station 118 may include one or more receptacles or positions for receiving a processing cell or chamber 140, such as the EBR chamber of the invention. A fluid/chemical replenishing system 120, such as an electrolyte or deplating solution replenishing system, may be positioned adjacent system platform 100 and be in fluid communication with process cells or chambers 140 in order to circulate processing fluid thereto. System platform 100 also includes a control system 122, which may be a programmable microprocessor, configured to interface with the various components of the system platform 100 and provide controlling signals thereto. Control system 122 may generally operate to control the cooperative operation of each of the components that together form system platform 100.

Loading station 110 generally includes one or more substrate cassette receiving areas 124, one or more loading station transfer robots 128, and at least one substrate orientor 130. The number of substrate cassette receiving areas 124, loading station transfer robots 128, and substrate orientors 130 included in the loading station 110 may be configured according to the desired throughput of the system. As shown for one exemplary embodiment in FIGS. 2A and 2B, the loading station 110 includes two substrate cassette receiving areas 124, two loading station transfer robots 128, and one substrate orientor 130. Substrate cassettes 132 containing substrate 134 are loaded onto the substrate cassette receiving areas 124 in order to introduce substrates 134 into the electroplating system platform 100. The loading station transfer robots 128 then transfer substrates 134 between the substrate cassette 132 and the substrate orientor 130. The substrate orientor 130 positions each substrate 134 in a desired orientation to ensure that the substrate 134 is properly processed. The loading station transfer robot 128 also transfers substrates 134 between the loading station 110 and the SRD station 112 and between the loading station 110 and the thermal anneal chamber 111. Robot 116 may then be used to transfer substrates from leading station 110 to processing chambers 140. Once processing of substrates 134 is complete, substrates 134 may be returned to cassettes 132 for removal from system 100. Although FIGS. 2A and 2B illustrate an exemplary processing platform that may be used to implement the EBR chamber of the invention, the scope of the present invention is not limited to any specific processing platform. As such, other semiconductor processing systems, such as the Endura Platform, the Producer Platform, and the Centura Platform, all of which are available from Applied Materials Inc. of Santa Clara, Calif., for example, may also be used to implement the EBR chamber of the invention.

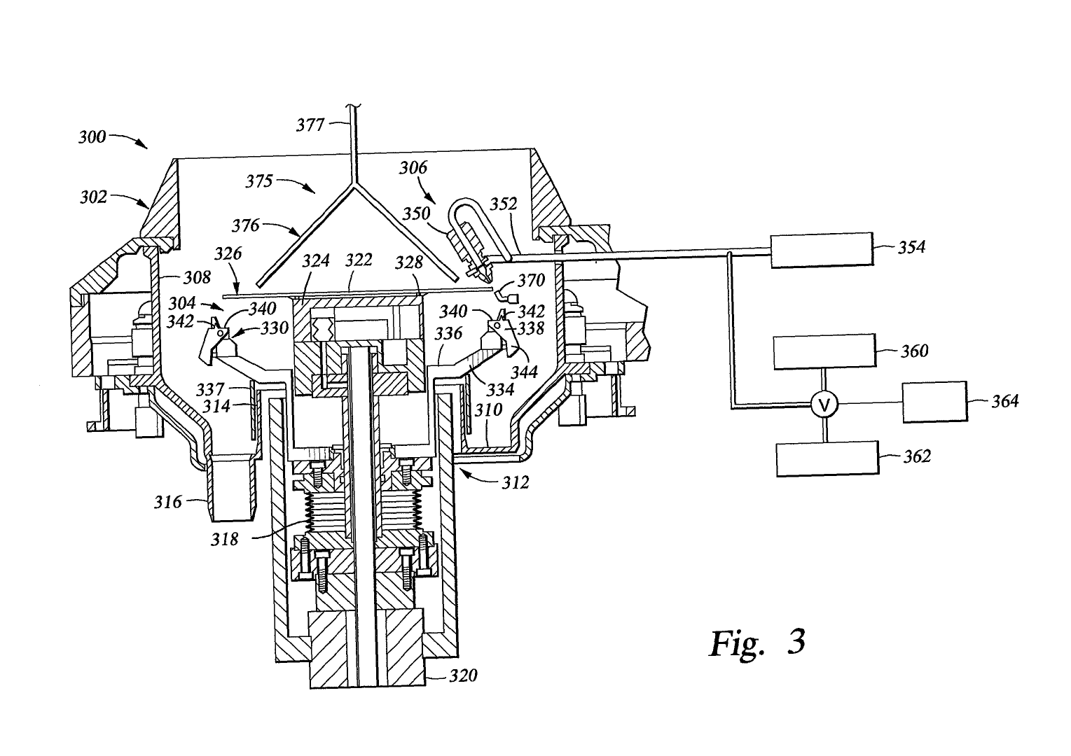

FIG. 3 illustrates a sectional view of an exemplary EBR chamber 300 of the invention. EBR chamber 300 may be a stand-alone chamber system, or chamber 300 may be disposed as a component of a larger system, such as an electro-chemical deposition system or other deposition system similar to that shown in FIGS. 2A and 2B. Therefore, EBR chamber 300 may be implemented, for example, into system 100 as a processing cell or chamber 140. EBR chamber 300 includes a container 302, a substrate support member 304 and a fluid/chemical delivery assembly 306. Container 302 preferably includes a cylindrical sidewall 308, a container bottom 310 having a central opening 312 extending therethrough and communicating with the area outside of chamber 300, and an upturned inner wall 314 extending upwardly from the peripheral edge of the central opening 312. A fluid outlet 316 is connected to the container bottom 310 to facilitate draining of the used fluids and chemicals from the EBR chamber 300. Fluids drained from chamber 300 may then be re-circulated to replenishing system 120.

The substrate support member 304 is generally disposed above the central opening 312 and includes a lift assembly 318 and a rotation assembly 320 extending through central opening 312. Lift assembly 318 preferably includes a bellows-type lift or a screw-type stepper motor lift assembly, which are well known in the art and commercially available. Lift assembly 318 facilitates transfer and positioning of the substrate 322 on the substrate support member 304 between various vertical positions. The rotation assembly 320 preferably includes a rotary motor that is attached below the lift assembly 318. The rotation assembly 320 operates to rotate the substrate 322 during the edge bead removal process.

The substrate support member 304 preferably includes a vacuum chuck 324 that secures a substrate 322 from the substrate backside and does not obstruct the substrate edge/exclusion zone 326. Preferably, an annular seal 328, such as a compressible O-ring, is disposed at a peripheral portion of the vacuum chuck surface to seal the vacuum chuck 324 from the fluids and chemicals used during the edge bead removal process. The substrate support member 304 includes a substrate lift 318 that facilitates transfer of a substrate from a robot blade of a transfer robot (not shown) onto the substrate support member 304. The substrate lift 330 may include a spider clip assembly that also can be used to secure a substrate during a spin-rinse-dry process. The spider clip assembly may, for example, include a plurality of arms 334 extending from an annular base 336 and a spider clip 338 pivotally disposed at the distal end of the arm 334. The annular base 336 includes a downwardly extending wall 337 that overlaps the upturned inner wall 314 to contain fluids used during processing inside the container 302. The spider clip 338 includes an upper surface 340 for receiving the substrate, a clamp portion 342 for clamping the substrate, and a lower portion 344 that causes the clamp portion 342 to engage the edge of the substrate due to centrifugal force when the substrate support member is rotated. Alternatively, the substrate lift 330 comprises commonly used substrate lifts in various substrate processing apparatus, such as a set of lift pins or a lift hoop disposed on a lift platform or lift ring in or around the vacuum chuck body.

The fluid/chemical delivery assembly 306 generally includes one or more nozzles 350 disposed on one or more dispense arms 352. The dispense arm 352 may extend through the container sidewall 308 and be attached to an actuator 354 that extends and retracts to vary the position of nozzle 350 over substrate 322. By having an extendable dispense arm 352, nozzle 350 can be positioned over the substrate to point nozzle 350 from an interior portion of substrate 322 toward the edge/exclusion zone 326 of substrate 322, which enhances the control over the delivery of the etchant/fluids to the substrate edge 326. Alternatively, the dispense arm 352 is fixedly attached to the container sidewall 308, and the nozzle 350 is secured to the dispense arm in a position that does not interfere with vertical substrate movement in the container 302.

Preferably, the dispense arm 352 includes one or more conduits extending through the dispense arm for connecting nozzle 350 to an etchant source. A variety of etchants are well known in the art for removing deposited metal from a substrate, such as, for example, sulfuric acid, hydrochloric acid, nitric acid, and other acids available commercially for use in etching or metal removal chambers. Alternatively, the nozzle 350 is connected through a flexible tubing disposed through the conduit in the dispense arm 352. Preferably, the nozzles 350 are disposed in a paired arrangement at positions above and below the substrate to deliver fluids/chemicals to the upper edge surface and the lower edge surface of the substrate, respectively. The nozzles 350 can be selectively connected to one or more chemical/fluid sources, such as a deionized water source 360 and an etchant source 362, where computer control 364 switches the connection between the one or more fluid/chemical sources according to a desired program. Alternatively, a first set of nozzles are connected to the deionized water source and a second set of nozzles are connected to the etchant source, and the nozzles are selectively activated to provide fluids to the substrate.

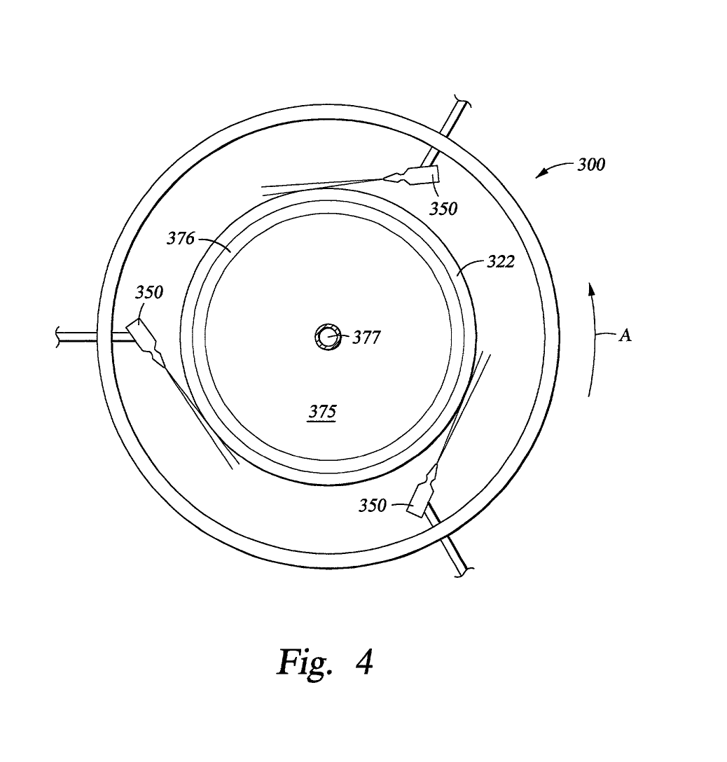

Preferably, the nozzles 350 are disposed at an angle to provide fluids near a peripheral portion of the substrate at a substantially tangential direction. FIG. 4 is a plan view of EBR chamber 300 illustrating an exemplary embodiment of the nozzle positions for edge bead removal. As shown, three nozzles 350 are disposed substantially evenly spaced about an interior surface of the container sidewall 308. Each nozzle 350 is disposed to provide fluids to an edge portion 326 of the substrate 322 and is positioned to provide sufficient space to allow vertical substrate movement between a processing position and a transfer position. Preferably, the fluid delivery or spray pattern is controlled by the shape of the nozzle and the fluid pressure to limit fluid delivery to a selected edge exclusion range. For example, the etchant is restricted to an outer 3 mm annular portion of the substrate to achieve 3 mm edge exclusion. The nozzles are positioned to provide the etchant at an angle of incidence to the surface of the substrate that controls splashing of the etchant as the etchant comes into contact with the substrate.

A conically shaped shield 375 is positioned radially inward from nozzle 350 and is configured to prevent overspray, splashing, or misting from nozzle 350 from depositing on the production surface of substrate 322. Generally, the production surface is the inner surface of substrate 322 bound on an outer perimeter by the exclusion zone 326, which is generally 3-6 mm around the outer perimeter of substrate 322. Shield 375 generally includes a circular base portion 503 having an annular gas distribution nozzle 504 formed around the perimeter of base portion 503. Base portion 503 generally extends toward an upper portion of shield 375, thus forming a generally solid intermediate portion. The upper portion of shield 375 includes a gas receiving member. The annular gas distribution nozzle 504 generally has a radius slightly less than the radius of the substrate being processes. As such, the annular gas distribution nozzle 504 is generally positioned radially inward from the exclusion zone/perimeter of the substrate being processed. Nozzle 504 may, for example, be positioned about 1 mm to about 10 mm inward from the exclusion zone. The gas distribution nozzle 504 is in fluid communication with a gas supply conduit 377 through an interior portion of shield 375. Conduit 377 may extend out the top of chamber 300, or alternatively, out through a sidewall of chamber 300. Conduit 377, which may also operate to provide structural support to shield 375, may be in mechanical communication with an actuator, in similar fashion to actuator 354 used with nozzle 350, so that nozzle 375 may be selectively moved into and out of a processing position, which may allow grater clearance for substrate loading and unloading processes. Therefore, when a chemical solution is dispensed from nozzle 350, a gas may be flowed from the shield gas distribution nozzle 504. The gas flow, which may be a nitrogen gas flow, for example, will generally be directed radially outward from the center of circular base portion 503 as a result of the structural configuration of shield 375 and nozzle 504, as generally indicated by arrows 502. The radial gas flow generated by shield 375 operates to prevent EBR solutions from depositing on the production surface, as the splash and/or mist of solution is caused to flow outward from substrate 322 as a result of the gas flow. Further, shield 375 may be a solid conic, and therefore, the conical side portions 376 also operate to prevent EBR solution from depositing on the production surface of substrate 322. Generally, the radius 501 of shield 375 is selected to closely match the size of the production surface of a substrate, and therefore, gas nozzle 504 may be positioned proximate the outer terminating edge of the production surface of the substrate. This allows nozzle 350 to dispense an EBR solution onto the exclusion zone, while allowing shield 375 to effectively prevent EBR solutions from contacting the production surface of the substrate.

During operation of system 300, substrate 322 is rotated in order to provide substantially equal exposure to the etchant/edge bead removal solution at the peripheral portion of substrate 322. Preferably, the substrate 322 is rotated in the same direction as the direction of the etchant spray pattern to facilitate controlled edge bead removal. For example, as shown in FIG. 4, the substrate is rotated in a counter-clockwise direction, as indicated by arrow A, which corresponds to the counter-clockwise spray pattern generated by nozzles 350. Substrate 322 is preferably rotated between about 100 rpm to about 1000 rpm, more preferably between about 500 rpm and about 700 rpm. The effective etch rate (i.e., the amount of copper removed divided by the time required for removal) is a function of the etch rate of the etchant, the velocity of the etchant contacting the substrate edge, the temperature of the etchant, and the velocity of the substrate rotation. These parameters can be varied to achieve particular desired results.

The loading process for substrate 322 includes positioning the substrate above the substrate support member 304 of the EBR module 300, and the substrate lift 318 lifts the substrate off of a transfer robot blade (not shown). The robot blade retracts and the substrate lift 318 lowers the substrate onto the vacuum chuck 324. Once the loading process is complete, the vacuum system is activated to secure the substrate 322 to substrate support member 304. Substrate support member 304 is then rotated at the selected rotation rate with the substrate disposed thereon, and a gas supply (not shown) is activated so that a gas flow may be established through shield 375, and more particularly, through gas distribution nozzle 504. The gas flow, once initiated, generates an annular gas glow radiating outward from the center of the lower portion 503 of shield 375. Once the substrate support member is rotating and the radial gas flow is established, nozzles 350 may be activated to deliver an edge bead removal solution onto the peripheral portion of the substrate 322. The solution, which is essentially an etch solution, operates to etch/remove the edge bead from substrate 322. The etching process is performed for a pre-determined time period sufficient to remove the excess deposition on the substrate edge (i.e., the edge bead and any excess metal layers). Thereafter, substrate 322 is preferably cleaned utilizing deionized water in a spin-rinse-dry process. The spin-rinse-dry process typically involves delivering deionized water to the substrate to rinse residual etchant from the substrate and spinning the substrate at a high speed to dry the substrate. The substrate is then transferred out of the EBR chamber 300 after the edge bead removal process and the spin-rinse-dry process, and the substrate is ready for other processes, such as a thermal anneal treatment and other substrate processing.

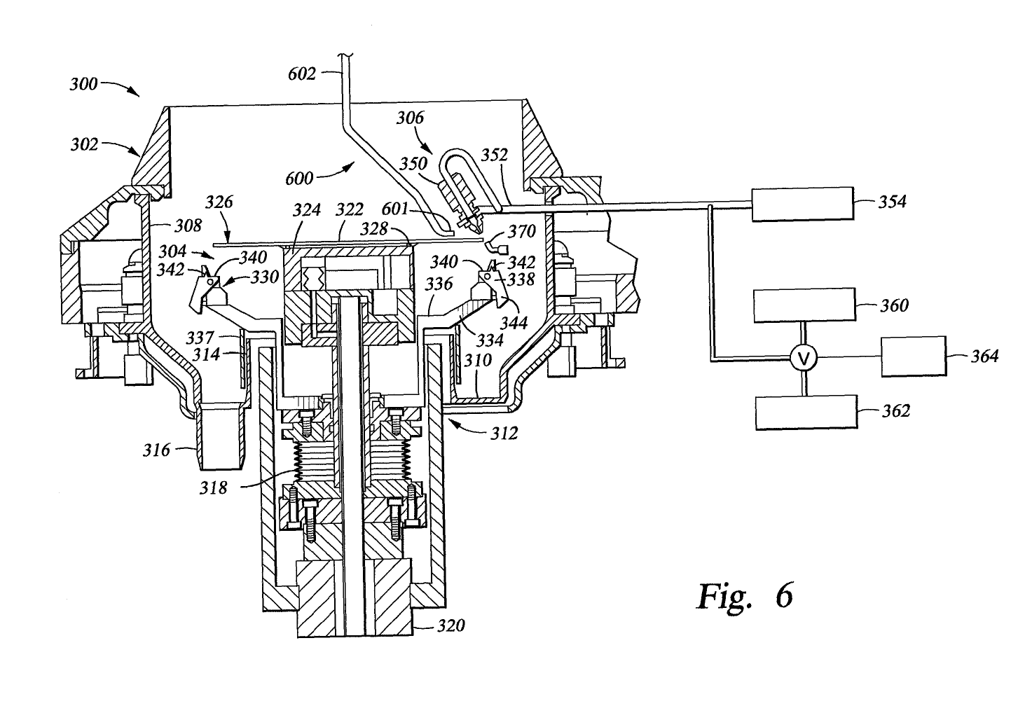

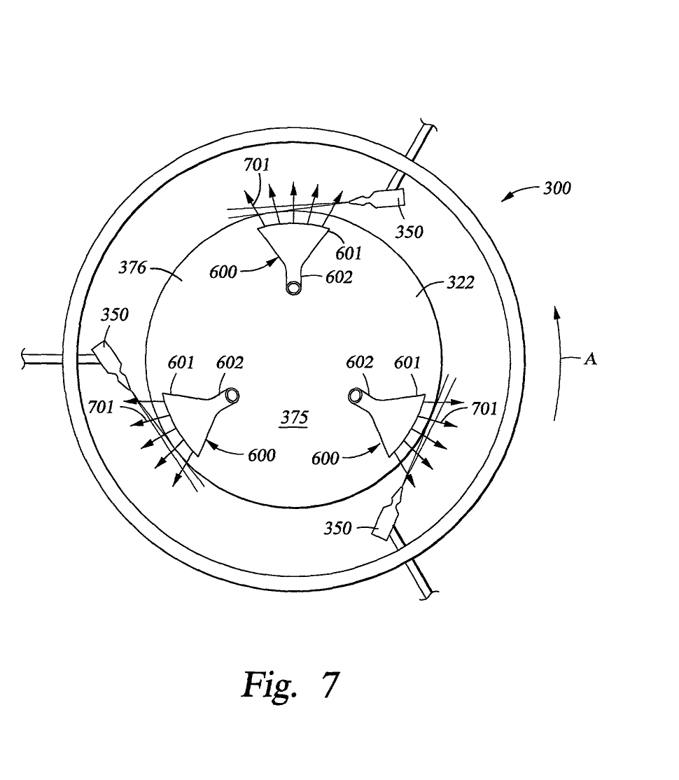

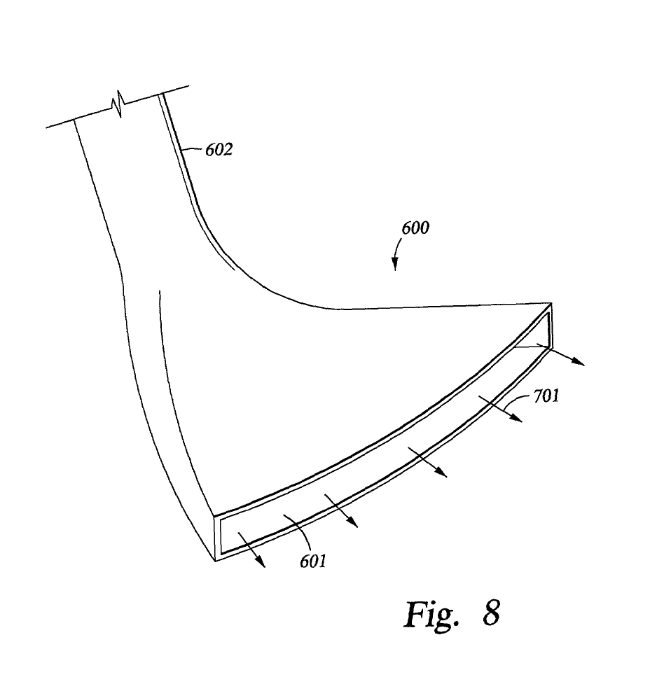

In another embodiment of the invention, the conical shield 375 may be replaced with smaller individual shields 600, as illustrated in FIGS. 6 and 8. Shields 600 may be individually positioned proximate each of nozzles 350. Each shield 600 includes a gas inlet 602, which is in communication with a gas supply (not shown), and a gas distribution nozzle 601. Each gas distribution nozzle 601 may be positioned proximate the area on the substrate where the edge bead removal solution is deposited by fluid nozzles 350, as illustrated in FIG. 7. Nozzle 601 are generally semicircular/arc shaped, and are configured to conform to the inner perimeter of the exclusion zone of the substrate positioned thereunder. As such, nozzle 601 may flow a gas supplied thereto via inlet 602 in a radially outward direction, as indicated by arrows 701, across the outer perimeter of the substrate, which is generally termed the exclusion zone. Therefore, when shields 600 are positioned proximate the area where nozzles 350 are depositing the EBR solution onto the substrate, the radially outward gas flow operates to prevent solution mist or splash from depositing on the production surface of the substrate, as the radially outward gas flow causes mist and splash to be carried outward away from the substrate production surface.

While the foregoing is directed to exemplary embodiments of the invention, other and further embodiments of the invention may be devised without departing from the basic scope thereof. For example, although specific shield configurations and shapes have been disclosed by the above exemplary embodiments, the invention is not limited to these shapes or configurations. Rather, various other shaped and configurations configured to generate a generally outward gas flow may be implemented without departing from the true scope of the invention, where the scope of the invention is determined by the following claims.

1. An apparatus for removing an edge bead from a substrate, comprising:
a selectively rotatable substrate support member configured to support a substrate thereon;
at least one fluid distribution nozzle positioned to distribute an edge bead removal solution onto the substrate; and
a conically shaped shield member positioned above the substrate support member, the shield member having a fluid conduit formed therein and an annular gas distribution nozzle positioned on a lower portion of the shield member, the annular gas nozzle being in fluid communication with the fluid conduit.

2. The apparatus of claim 1, wherein a radius of the annular gas distribution nozzle is less than a radius of the substrate.

3. The apparatus of claim 1, wherein the annular gas distribution nozzle is positioned radially inward of the at least one fluid distribution nozzle.

4. The apparatus of claim 1, wherein a radial distance from the annular gas distribution nozzle to an exclusion zone of the substrate is between about 1 mm and about 10 mm.

5. The apparatus of claim 1, wherein the annular gas distribution nozzle is configured to generate a gas flow that radiates outward from a center of the substrate.

6. The apparatus of claim 5, wherein the gas flow is configured to prevent an edge bead removal solution from depositing on a production surface of the substrate.

7. The apparatus of claim 1, wherein the conically shaped shield member includes a continuous intermediate shield portion.

8. The apparatus of claim 7, wherein the continuous intermediate shield portion is configured to prevent an edge bead removal solution from splashing over the annular gas distribution nozzle.

9. The apparatus of claim 1, wherein the at least one fluid distribution nozzle is configured to dispense an edge bead removal solution therefrom.

10. The apparatus of claim 1, wherein the annular gas distribution nozzle is configured to dispense an inert gas therefrom.

11. An apparatus for removing an edge bead from a substrate, comprising:
a rotatable substrate support member configured to support a substrate in a face up position;
at least one fluid distribution nozzle positioned to distribute an edge bead removal solution onto an exclusion zone of the substrate; and
at least one shield member positioned proximate each of the at least one fluid distribution nozzles, each of the at least one shield members having a gas distribution nozzle positioned thereon.

12. The apparatus of claim 11, wherein the at least one shield member further comprises:
an upper portion having a gas receiving member;
a lower portion having the gas distribution nozzle; and
a solid intermediate shield portion interconnecting the upper portion and the lower portion, the intermediate portion having a gas conduit formed therein that is in fluid communication with the gas receiving member and the gas distribution nozzle.

13. The apparatus of claim 11, wherein the gas distribution nozzle further comprises an arc shaped nozzle configured to distribute a gas flow that radiates outwardly across the exclusion zone.

14. The apparatus of claim 13, wherein the arc shaped nozzle is positioned immediately above the substrate surface radially inward from the at least one fluid distribution nozzle.

15. The apparatus of claim 1 1, wherein the at least one shield member is in fluid communication with a gas supply.

16. The apparatus of claim 11, wherein the gas supply is at least one of a nitrogen gas supply, an argon gas supply, and a helium gas supply.

17. The apparatus of claim 11, wherein the at least one fluid distribution nozzle further comprises a conically shaped nozzle member having a gas receiving member on an upper end and an annular gas distribution nozzle on a lower end, the gas receiving member being in fluid communication with annular gas distribution nozzle through an intermediate gas conduit.

18. The apparatus of claim 11, wherein the at least one fluid distribution nozzle further comprises three individual fluid distribution nozzles positioned on an annular pattern above the substrate, each of the three individual fluid distribution nozzles being configured to distribute the edge bead removal solution onto the exclusion zone of the substrate rotating below.

19. The apparatus of claim 18, wherein each of the three individual fluid distribution nozzles includes a gas receiving end, a nozzle end, and an intermediate portion having a fluid conduit formed therein that fluidly connects the gas receiving end to the nozzle end.

20. The apparatus of claim 18, wherein the nozzle end further comprises an arc shaped gas distribution nozzle, wherein the arc shaped gas distribution nozzle is configured to have a corresponding radius that is about the same as the radius of the exclusion zone of the substrate.

21. An apparatus for removing an edge bead from a substrate, comprising:
a rotatable substrate support member configured to receive a substrate thereon in a face up position;
at least one fluid distribution nozzle positioned above the substrate support member and being configured to dispense an edge bead removal solution onto an exclusion zone of the substrate; and
means for shielding a production surface of the substrate from the edge bead removal solution.

22. The apparatus of claim 21, wherein the means for shielding comprises an annular gas distribution nozzle positioned radially inward from the exclusion zone, the gas distribution nozzle being configured to dispense a gas flow that radiates outward across the exclusion zone.

23. The apparatus of claim 21, wherein the means for shielding comprises at least one gas distribution nozzle assembly positioned proximate each of the at least one fluid distribution nozzles, each of the at least one gas distribution nozzle assemblies having an arc shaped gas distribution nozzle configured to dispense a gas flow that radiates outward across the exclusion zone.

24. A method for removing an edge bead from a substrate, comprising:
rotating a substrate on a substrate support member;
dispensing an edge bead removal solution onto an exclusion zone of the substrate with at least one fluid nozzle;
dispensing a gas flow from at least one gas nozzle positioned above the substrate radially inward from the at least one fluid nozzle, the gas flow radiating outward across the exclusion zone.

25. The method of claim 24, wherein dispensing the gas flow further comprises positioning an annular gas distribution nozzle immediately above the substrate, the annular gas distribution nozzle having a radius that is less than a radius of the exclusion zone.

26. The method of claim 24, wherein dispensing the gas flow further comprises positioning a gas distribution nozzle radially inward from each of the at least one fluid nozzles, the gas distribution nozzle having a arc shaped gas dispensing end configured to correspond to the exclusion zone of the substrate.
